(19) United States
(12) Patent Application Publication
(10) Pub. No.: US 2008/0031483 A1
(43) Pub. Date: Feb. 7, 2008

(54) Insulated cooler with internal audio system docking station and integral speakers

(76) Inventor: James W. Hill, Myrtle Beach, SC (US)

Correspondence Address: William Propp, Esq., 8205 Santa Monica Blvd., PMB1-245, West Hollywood, CA, 90046, US

(21) Appl. No.: 11/499,540

(22) Filed: Aug. 4, 2006

(51) Int. Cl. H04R 1/02; H04R 9/06

(52) U.S. Cl. 381/334; 381/87

(57) ABSTRACT

An insulated cooler has an outer housing, an inner lining and an insulation layer between the housing and lining. The inner lining forms a first storage compartment and along one wall of the lining forms a second audio system docking station compartment. The audio system can be removed and replaced in the docking station. A pair of speakers on the exterior housing positioned within the insulation layer is connected through an amplifier to the audio system in the docking station compartment. An internal RF receiver and an external RF transmitter control the audio system. A battery power source drives the amplifier and can recharge the audio system power source. A solar cell on the outside lid of the cooler can recharge the battery power source.

### BACKGROUND OF THE INVENTION

This invention relates generally to an insulated cooler and, more particularly, this invention is directed to an insulated cooler with an internal audio system and integral external speakers.

Insulated coolers are portable containers used to carry food and beverages for social or leisure activities. Most coolers are rigid plastic box-like structures made with foam or foam-filled walls, and have a removable or hinged lid to permit access to the inside. The coolers minimize the heat transfer between the articles held inside the cooler and the outside environment. Coolers can keep hot food hot relative to the outside but typically keep chilled or frozen food and beverages at a cool or cold temperature relative to the outside.

Social or leisure activities can involve music. A radio or cassette player can accompany the insulated cooler to the social or leisure event. The user can listen to the sounds and music from the radio while enjoying the food and beverages from the cooler.

Several insulated cooler designs combine the cooler with a radio. Typically, the radio is mounted in a recess in the exterior of the front wall of the cooler or attached to the exterior surface of the front wall of the cooler.

The radio, cassette player or audio unit for these prior art coolers is exposed to the outside environment, such as rain, dust, sand, heat, or cold, whether the audio unit is in use or not. The cooler does not have any sort of covering to protect the audio unit from the environment. The audio unit is also unprotected from normal wear and tear, as the audio unit on the exterior surface of the cooler is bumped into, dropped on the ground, hit by objects, and the like. Also, the audio unit can only be used in conjunction with the cooler. The audio unit cannot be easily used in a small space, as a hand-held unit, in an inside room, or at a social or leisure activity where a cooler is not needed or would detract from the activity.

The problem with providing an audio unit in the interior of the cooler is projecting the music from within the cooler to the outside environment. The interior audio unit must also be protected from the extremes of heat and cold from the food or beverages being insulated within the cooler. And the interior audio system must be easily accessible for the user.

There are several cooler/audio unit patents where the audio unit is removable from the cooler.

Long (U.S. Pat. No. 4,700,395) has a miniature audio unit secured to the outside of a cooler lid by a restraining strap.

Ellison (U.S. Pat. No. 5,979,175) has an audio unit secured to the inside of the cooler lid by removable fasteners. The face of the audio unit shows through a sidewall of the lid.

Kirby et al. (U.S. Pat. No. 4,571,740) has a radio and speakers mounted to an auxiliary panel. The auxiliary panel is recoverably fastened to the exterior front sidewall of the cooler.

It is an object of the present invention to provide an audio system within an insulating cooler.

It is another object of the present invention to provide an audio system, which is removable from the insulating cooler.

### SUMMARY OF THE INVENTION

According to the present invention, an insulated cooler has an internal audio system and integral speakers.

The insulated cooler has a generally rigid outer housing and a generally rigid inner lining defining a first primary storage compartment. An insulation layer fills the space between the walls of the outer housing and the inner lining. The inner lining forms a rectangular box-like storage compartment, as the outer housing forms a rectangular box-like cooler. A cooler lid is pivotably mounted on the outer housing to cover the open end of the interior primary storage compartment.

A second compartment extends from the front wall of the inner lining in the interior primary storage compartment. The second compartment has a docking station where an audio system can be positioned. The audio system is removeable and replaceable in the docking station. The audio system can be an iPod device or an MP3 player or other digital music and entertainment player; or a radio receiver, such as an AM radio or FM radio or AM/FM radio or satellite radio; or a cellphone, Blackberry or other communications device that also plays or receives music or entertainment.

A pair of speakers is positioned in the outer housing front wall and is integral in the insulation layer. An acoustic port extends from the outer housing front wall through the insulation layer to the back of each speaker.

The internal audio system is connected by wiring from the inner lining of the second compartment through the insulation layer to an amplifier. The amplifier is connected by wiring through the insulation layer to the pair of speakers on the external housing.

An internal RF receiver and an external RF transmitter control the audio system.

A battery power source is positioned within the insulation layer and is connected by wiring to the audio system and the amplifier. The battery power source drives the amplifier and can recharge the audio system power source.

A solar cell on the upper exterior surface of the cooler lid is connected by wiring to recharge the battery power source.

The audio system is within the thermally insulated cooler.

The insulated cooler has a pair of carrying handles, with each handle attached to the side walls of the cooler housing. Additionally, a u-shaped telescoping carrying handle is attached to the back wall of the cooler housing. A pair of wheels is attached to the back of each of the side walls of the cooler housing.

Other aspects of the invention will become apparent from the following more detailed description, taken in conjunction with the accompanying drawings.

### BRIEF DESCRIPTION OF THE DRAWINGS

The preferred embodiments of this invention will be described in detail, with reference to the following figures wherein:

FIG. 1 is a perspective view of the insulated cooler with an internal audio system and integral speakers of the present invention.

FIG. 2 is a partial cut-away view of the insulated cooler of FIG. 1.

FIG. 3 is a top view of the insulated cooler of FIG. 1.

FIG. 4 is a circuit diagram for the internal audio system and integral speakers of the insulated cooler of the present invention.

### DETAILED DESCRIPTION OF PREFERRED EMBODIMENTS

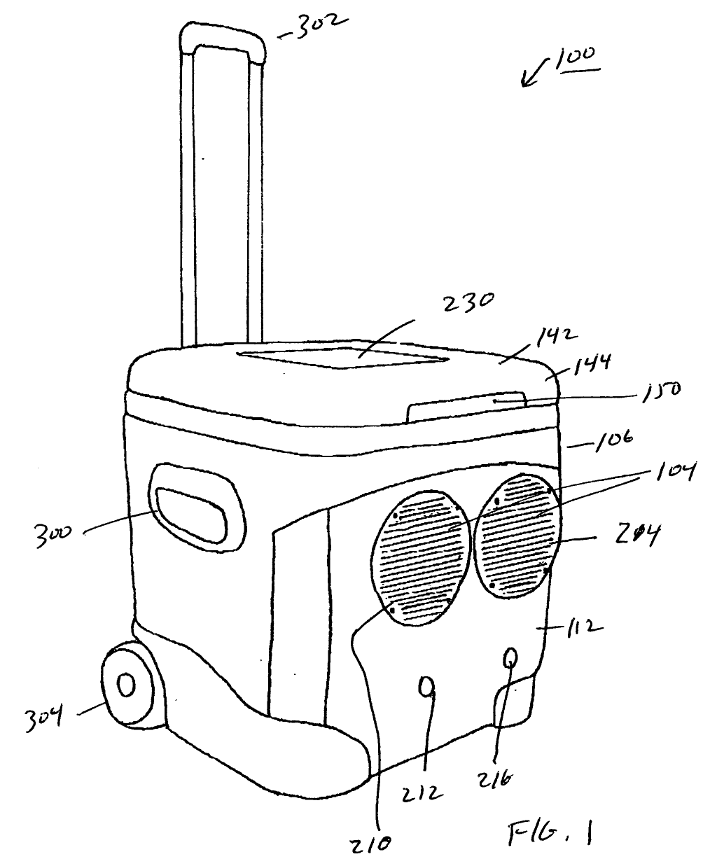

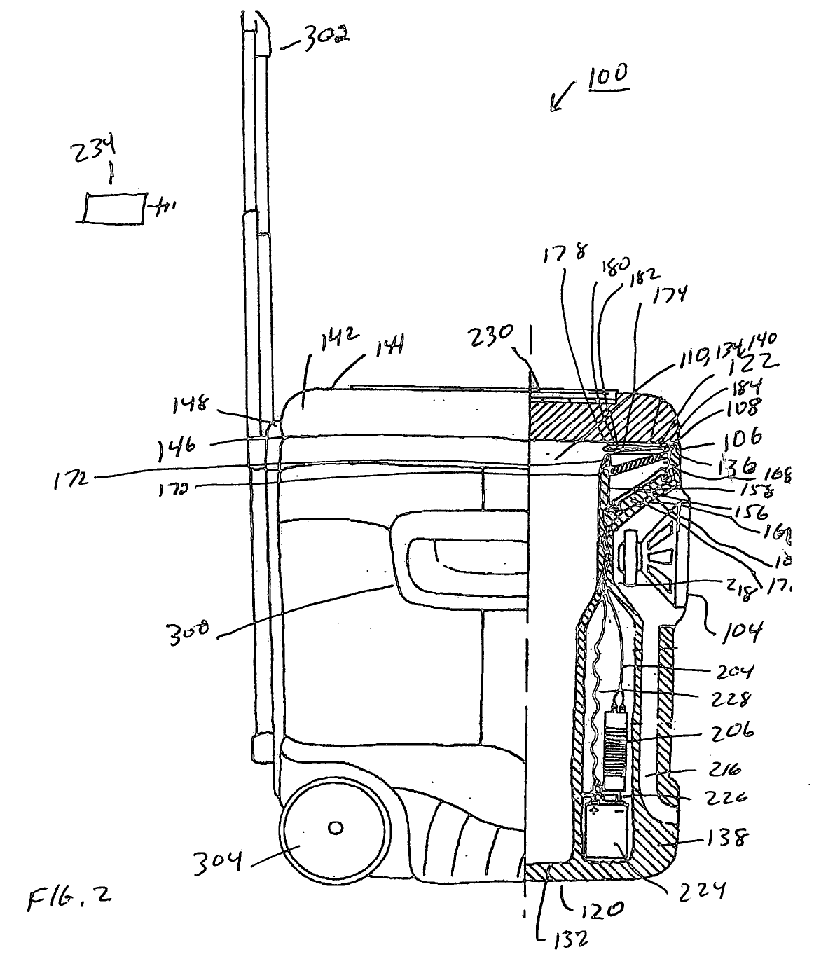

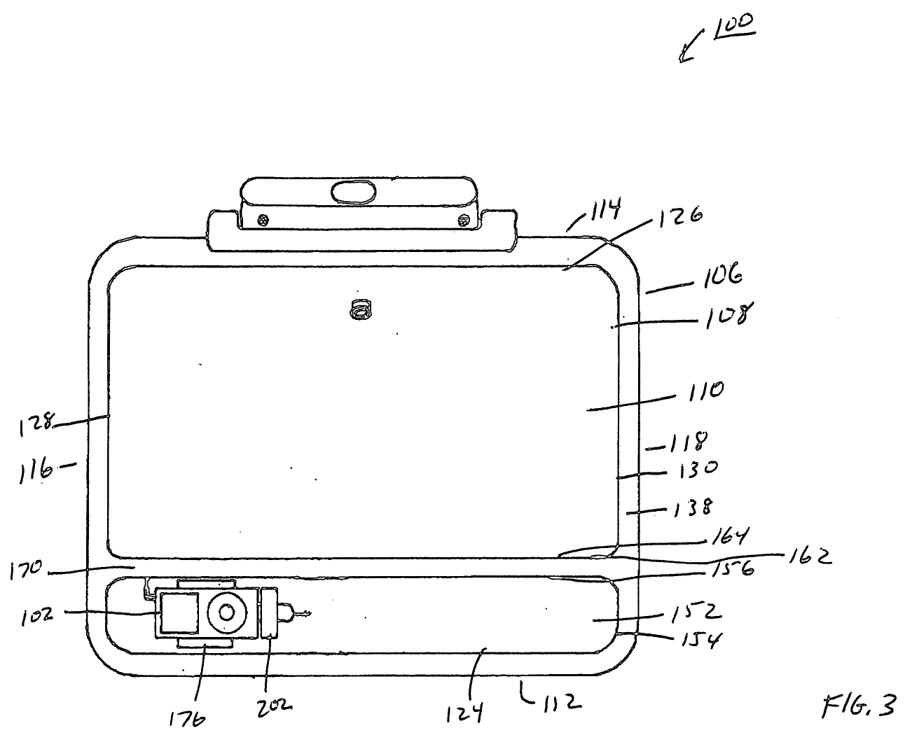

Reference is now made to FIG. 1, FIG. 2 and FIG. 3 illustrating a portable insulated cooler 100 with an internal audio system 102 and integral speakers 104 of the present invention.

The insulated cooler 100 has a generally rigid outer housing 106 and an inner lining 108 defining a first or primary storage compartment 110.

As best seen in FIG. 3, the outer housing 106 of the cooler 100 is a generally rigid structure having an exterior front wall 112, an exterior rear wall 114 opposite the exterior front wall, an exterior left side wall 116, an exterior right side wall 118 opposite the exterior left side wall, and an exterior bottom wall 120 (shown in FIG. 2) at right angles to the front wall, back wall, and two side walls. The outer housing has an open end 122 on the top side of the housing.

An inner lining 108 is positioned inside the outer housing 106. The inner lining defines the primary or first storage compartment 110 of the cooler. The inner lining 108 is a generally rigid structure having an interior front wall 124, an interior rear wall 126 opposite the interior front wall, an interior left side wall 128, an interior right side wall 130 opposite the interior left side wall, and an interior bottom wall 132 (shown in FIG. 2) at right angles to the front wall, back wall, and two side walls. The inner lining has an open end 134 at the top side of the lining. The interior walls of the inner lining correspond to the outer walls of the housing.

The outer housing 106 and the inner lining 108 are closed around the upper edges 136 of the front wall, back wall, and two side walls of the outer housing and the inner lining. The empty space or cavity between the walls of the outer housing and the inner lining is filled with insulating material such as plastic foam to form an insulation layer 138 between the outer housing and the inner lining. The outer housing and the inner lining may be molded from plastic. The upper edges 136 form an open end 140 at the top side of the cooler.

Typically the inner lining 108 forms a rectangular box-like storage compartment. Also, typically the outer housing 106 forms a rectangular box-like cooler.

As best seen in FIG. 2, a cooler lid 142 is a generally rigid structure with a flat exterior upper surface 144 and a flat interior lower surface 146. The lid is rectangular and has essentially the same shape as the periphery of the open end 140 at the top side of the cooler. The lid is pivotably mounted on an upper portion of the exterior back wall of the housing by a hinge or hinges 148. When the lid is closed, the lid 142 will rest on the closed upper edges 136 of the front wall, back wall, and two side walls of the outer housing and inner lining of the cooler. As seen in FIG. 1, a latch 150 on the front of the lid will engage a corresponding hook (not shown) on the upper portion of the front wall to fasten the lid closed on the cooler and secure any food or beverages within the storage compartment in the cooler. When the lid is open, the user will have access through the open end to the primary storage compartment of the cooler. The cooler lid may have an insulation layer between the upper surface and lower surface.

As shown in FIG. 3, a second compartment 152 is positioned in the first storage compartment 110 of the insulated cooler extending from the interior front wall 124 of the inner lining 108. The second compartment 152 is a generally rigid structure defined by an inner lining 154. The inner lining 154 of the second compartment will share a front wall 124 and a portion of two side walls 128, 130 with the inner lining 108 of the first compartment 110. Similarly, the outer walls of the second compartment will share a front wall 112 and a portion of two side walls 116, 116 with the outer housing 106 of the first compartment 110. The second compartment adds a different front wall and different bottom wall for the inner lining and outer housing. The second compartment does not share the bottom wall with the first compartment.

The inner lining 154 of the second compartment 152 has a back wall 112 formed from the interior front wall 112 of the inner lining 108 of the first compartment 110, a left side wall 130 formed from the interior right side wall 130 of the inner lining of the first compartment, a right side wall 128 formed from the interior left side wall 128 of the inner lining of the first compartment, the right side wall being opposite the left side wall, and a front wall 156 opposite the back wall, and a bottom wall 158 (as seen in FIG. 2) at angles to the front wall, back wall, and two side walls of the inner lining of the second compartment. The front inner lining has an open end 160 at the top side of the lining.

The outer housing 162 of the second compartment 152 has an exterior back wall 112 formed from the exterior front wall 112 of the outer housing of the first compartment, an exterior left side wall 118 formed from the exterior right side wall 118 of the outer housing of the first compartment, an exterior right side wall 116 formed from the exterior left side wall 116 of the outer housing of the first compartment, the right side wall being opposite the left side wall, and an interior front wall 164 opposite the back wall, and a interior bottom wall 166 at angles to the front wall, back wall, and two side walls of the inner lining of the second compartment. The term exterior in reference to the outer housing of the second compartment refers to outside the cooler and the term interior in reference to the outer housing of the second compartment refers to inside the cooler, specifically inside the first compartment. The front outer housing has an open end 168 at the top side of the housing.

The upper edges of the back wall, left and right side walls of the second compartment are closed from the first compartment.

The outer housing front wall 164 and the inner lining front wall 156 of the second compartment are closed around the upper edges of the front wall. The empty space or cavity between the front and bottom walls of the outer housing and the inner lining is filled with insulating material 170 such as plastic foam to form an insulation layer between the outer housing and the inner lining. The outer housing and the inner lining may be molded from plastic. The upper edges 172 of the walls of the second compartment form an open end 174 at the top side of the second compartment.

Typically the inner lining 154 of the second compartment 152 forms a rectangular box-like storage compartment. Also, typically the outer housing 164 of the second compartment 152 forms a rectangular box-like structure. The second compartment may be molded from plastic.

A docking station 176 is inside the second compartment 152 on the bottom wall 158 of the inner lining 154. An audio system 102 can be removably positioned in the docking station 176 in the second compartment 152 within the insulated cooler 100.

The docking station 176 is sized to fit and hold the audio system 102 while allowing the audio system to connect with the other components in the insulated cooler like a power source and speakers. The docking station has flexible pads and adjustable sliding grips to hold audio systems of various sizes and various shapes.

The interior bottom wall 158 of the second compartment 152 can be angled relative to the back and side walls 112, 130, 128 of the second compartment and the inner lining 108 of the first compartment to increase ease of removing and replacing the audio system in the docking station in the second compartment. An angled second compartment also reduces the volume of the second compartment within the inner lining of the cooler and increases the volume of the first storage compartment to hold items.

The audio system 102 can be an iPod device or an MP3 player or other digital music and entertainment player. The audio system 102 can also be a radio receiver, such as an AM radio or FM radio or AM/FM radio or satellite radio. The audio system 102 can also be a cellphone, Blackberry or other communications device that also plays or receives music or entertainment.

The docking station 176 will physically secure the audio system 102 in the second compartment 152. The docking station will also have electrical elements to connect the audio system to other electronic components in the cooler. The audio system is removable from the docking station and the cooler.

As best seen in FIG. 2, a second compartment lid 178 is a generally rigid structure with a flat exterior upper surface 180 and a flat interior lower surface 182. The lid is rectangular and has essentially the same shape as the periphery of the open end 174 at the top side of the second compartment 152. The lid is pivotably mounted on an upper portion of the exterior back wall 112 of the second compartment by a hinge or hinges 184. When the lid is closed, the lid 178 will rest on the closed upper edges 172 of the front wall, back wall, and two side walls of the outer housing and inner lining of the second compartment. A latch 180 on the front of the lid 178 will engage a corresponding hook on the upper portion of the front wall of the second compartment to fasten the lid closed on the second compartment and separate any food or beverages within the first storage compartment from the docking station and any audio system in the second compartment in the cooler. The second compartment lid may have an insulation layer between the upper surface and lower surface.

The cooler lid 142 is adjacent and above the second compartment lid 178.

When the second compartment lid is closed, the audio system in the second compartment is protected from the food and beverages and their hot or cold temperature in the primary or first compartment of the cooler. When the second compartment lid is closed, the audio system in the second compartment is also protected from the environment outside the cooler itself.

When just the cooler lid is open and the second compartment lid is closed, the user can access just the food or beverage items in the first storage compartment while the second storage compartment is not accessible. A closed cooler lid will seal and separate the first storage compartment from the second audio system docking station compartment. The upper edges of the front wall and two side walls of the second compartment can additionally have waterproof seals and o-rings to further separate the first storage compartment from the second audio system docking station compartment.

When the cooler lid and the second compartment lid are both open, the user will have access through the open end to the audio system in the second storage compartment of the cooler.

One or more speakers 104, two speakers in this illustrative example, are positioned in a recess in the exterior front wall 112 of the housing extending into the insulation layer 138 between the exterior housing 106 and the inner lining of cooler 108. The speakers can be marine speakers or can have protective screens and/or waterproof and dustproof seaming means to protect them from the outside environment. The insulation layer protects the speakers from the heat or cold of the items inside the cooler.

The audio system will have an audio-out connector and a power-in connector to recharge the battery in the audio system.

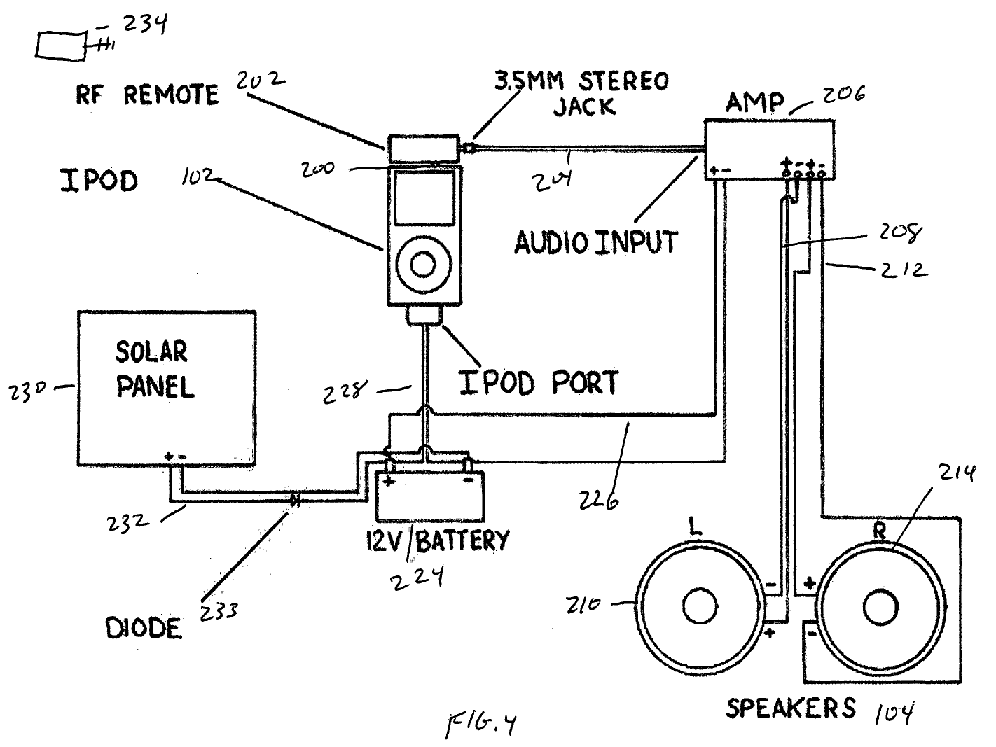

As best seen in FIG. 2 and FIG. 4, the internal audio system 102 is connected by wiring 200 to the RF (radio frequency) remote receiver 202 inside the second compartment 152. The RF receiver 202 will control the on/off, volume and selection of music or sounds from stored in the audio system. The RF remote receiver 202 is connected by wiring 204 through the insulation layer 138 to an amplifier 206 inside the insulation layer.

The amplifier 206 will amplify the music or sound signal from the audio system 102. The amplifier 206 is connected by wiring 208 through the insulation layer 138 to the first speaker 210 and is connected by wiring 212 through the insulation layer 138 to the second speaker 214 on the external housing 106. The pair 104 of external speakers 210, 214 will project the music and sounds from the internal audio system within the cooler.

As seen in FIG. 1 and FIG. 2, a first acoustic port 216 runs from the exterior front wall of the housing through the insulation layer 138 between the exterior housing 106 and the inner lining 108 of cooler 100 to the back 218 of the first speaker 210. A second acoustic port 220 runs from the exterior front wall of the housing through the insulation layer between the exterior housing and the inner lining of cooler to the back 222 of the second speaker 214. Acoustic ports improve the sound quality of the speakers.

Returning to FIG. 2 and FIG. 4, a battery power source 224 is positioned within the insulation layer between the exterior housing and the inner lining of cooler. The battery 224 is connected by a first set of wiring 226 to the amplifier 206 to drive the amplifier. The audio system 102 is typically run off an internal power source, such as a battery (not shown). The battery 224 is connected by a second set of wiring 228 to the audio system 102 to recharge the internal battery (not shown) in the audio system. The RF remote receiver 202 is also run off the internal battery (not shown) of the audio system.

The pair of speakers 104, the battery power source 224 and the amplifier 206 are integral with the insulated cooler. These components remain with the cooler when the audio system is removed. These components will function when the audio system is replaced and positioned within the docking system or when a different audio system is positioned within the docking system.

The audio system 102, pair of speakers 104, acoustic ports 216, 220, battery power source 224, and amplifier 206 are all along the front walls of the inner lining and outer housing and insulating layer. These components are lightweight and do not adversely effect the center of gravity of the insulated cooler. These components do not need to be positioned on opposing walls of the cooler to distribute their weight relative to the cooler.

The speakers and acoustic ports need to be along the same exterior wall of the cooler housing. The first battery, the amplifier and the second battery can be in the insulation layer inside any of the walls of the cooler. The audios system and second compartment can be along the inside wall of any of the walls of the inner lining of the cooler.

A solar cell 230 can be positioned on the upper exterior surface of the cooler lid. The solar cell is connected by wiring 232 through the hinge through the insulation layer to the battery power source 224. A diode 233 may be in the electrical path in the wiring 232 to allow current to flow in one direction only. The diode allows current to only flow from the solar cell to the battery power source, thus protecting the solar cell from any electricity back feeding from the battery power source. The solar cell will recharge the battery power source. A plastic window (not shown) can cover the solar cell to provide transmission of outside light while protecting the solar cell from the outside environment of water, heat, cold, dust and the like.

The audio system is within the thermally insulated cooler. A RF (radio frequency) remote transmitter unit 234 is used to control the audio system from outside the cooler.

The RF transmitter unit 234 will transmit a signal to the RF receiver 202. The RF receiver will control the audio system 102. The audio system 102 will send a music or sound signal to the amplifier 206. The amplifier will send an amplified music or sound signal to the speakers 104. The speakers 210 and 214 will emit the amplified signal as music or sound.

The battery power source drives the amplifier and recharges the internal battery of the audio system. The internal battery drives the audio system. A solar cell can recharge the battery power source.

Carrying means are provided for the insulated cooler with internal audio system of the present invention as best seen in FIG. 1.

A pair of carrying handles 300 is attached to the cooler housing 106, with a handle on each of the right and left side walls. The pair of carrying handles provides carrying means for the insulated cooler 100.

Additionally, a unshaped telescoping carrying handle 302 is attached to the back wall of the cooler housing 106. A pair of wheels 304 is attached to the cooler housing 106, with a wheel at the back of each of the right and left side walls. The telescoping handle and pair of wheels also provide carrying means for the insulated cooler.

Each speaker can have an acoustic port or the pair of speakers can share a single common acoustic port.

Instead of a solar cell to recharge the battery power source, an access panel (not shown) can be provided in the outer housing or inner lining of the cooler to allow the battery to be removed and replaced.

Instead of a second compartment lid, the cooler lid can seal the second compartment shut when closed over the primary or first compartment.

Instead of an internal battery, the audio system can be run off the battery power source. Similarly, the RF receiver can be run off the battery power source. And the internal battery of the audio system need not be rechargeable by the battery power source.

The second compartment need not extend along the entire width of the cooler. The second compartment can be positioned in the corner of a side wall and the front wall of the primary compartment or the corner of a side wall and the back wall of the primary compartment or just along a portion of a side wall, the front wall or the back wall of the primary compartment.

Alternately, a shoulder strap (not shown) could be attached between the right and left side wall to provide carrying means for the insulated cooler.

There are alternate insulated cooler designs that will also work with the present invention.

Typically, the cooler lid is permanently attached to the insulated cooler by a hinge or hinges. Alternately, the cooler and lid may not have a hinge means and the lid is completely removable from the cooler.

Rather than a rectangular box shape to the insulated cooler, the cooler can have a cylindrical shape. The cylindrical cooler will have a circular lid, which can be attached by a hinge to the cooler, or be removable by an internal screw to the lid and a corresponding external screw to the cooler.

Again alternately, the cooler can have a rectangular box shape but the lid can have an A-frame shape with triangular right and left side walls and a sloping rectangular front and back walls. The side walls of the cooler lid are connected at pivot points to the side walls of the cooler housing. The lid pivots open to the front or back of the housing to expose the storage compartment of the cooler or pivots closed in the middle on top of the storage compartment of the housing.

The insulated cooler has an open upper end, a closed lower bottom wall, a front wall, a rear wall, opposed side walls, and a hollow interior forming a primary storage compartment. A second compartment is within the primary compartment holding an audio system docking station compartment. The audio system is removable and repleacable in the docking station.

A pair of speaker are integral in the insulation layer and outer front wall of the cooler. Electrical wiring runs from the audio system in the docking station through the insulation layer to an amplifier and then to the speakers. An RF receiver controls the audio system in response to an external (to the cooler) RF transmitter. A battery power source drives the amplifier and recharges the audio system internal battery.

An acoustic port on the outside front wall runs through the insulation layer to the back of each speaker. Electrical wiring runs from a solar cell on the outside lid of the cooler to the battery power source to recharge the battery power source. A cooler lid is pivotably mounted to cover the open upper end of the primary compartment. A second compartment lid is pivotably mounted to cover the open upper end of the second compartment.

The cooler has a pair of carrying handles on the opposed outer housing side walls. The cooler also has a pair of wheels on the opposed outer housing side walls and a telescoping u-shaped handle on the outer housing back wall.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. An insulated cooler comprising
a rigid outer housing;
a rigid inner lining inside said outer housing;
an insulation layer between said outer housing and said inner lining;
a first storage compartment formed by said inner lining;
a lid on said outer housing for closing said first storage compartment;
a second storage compartment extending from a wall of said inner lining, said second storage compartment having a docking station;
an audio system for removably positioning in said docking station; and
at least one speaker in said insulation layer and a wall of said outer housing, said speaker connected to said docking station, wherein when said audio system is positioned in said docking station, said audio system plays through said at least one speaker.

2. The insulated cooler of claim 1 wherein said audio system is an iPod, an MP3 player or other digital music and entertainment player.

3. The insulated cooler of claim 1 wherein said audio system is a radio receiver, an AM radio, FM radio, AM/FM radio or satellite radio.

4. The insulated cooler of claim 1 wherein said audio system is a cellphone, Blackberry or other communications device that also plays or receives music or entertainment.

5. The insulated cooler of claim 1 further comprising
a battery power source and an amplifier in said insulation layer, said battery power source driving said amplifier and said amplifier driving said at least one speaker.

6. The insulated cooler of claim 5 wherein said battery power source recharges a power source inside said audio system.

7. The insulated cooler of claim 6 further comprising
a solar cell on the outer surface of said lid, said solar cell recharging second battery power source.

8. The insulated cooler of claim 1 further comprising
an RF receiver connected to said audio system inside said insulated cooler and an RF transmitter outside said insulated cooler, said RF receiver and said RF transmitter controlling said audio system inside said insulated cooler.

9. The insulated cooler of claim 1 further comprising
a second lid on said second storage compartment for closing said second storage compartment.

10. The insulated cooler of claim 1 further comprising
an acoustic port between said wall of said outer housing through said insulation layer to the back of said at least one speaker.

11. An insulated cooler comprising
a rigid outer housing having a bottom wall, a front wall, a back wall, a left side wall and a right side wall forming a generally rectangular structure;
a rigid inner lining inside said outer housing, said inner lining having a bottom wall, a front wall, a back wall, a left side wall and a right side wall forming a generally rectangular structure;
an insulation layer between said walls of said outer housing and said walls of said inner lining;
a first storage compartment formed by said walls of said inner lining;
a first lid hinged on said back wall of said outer housing for closing said first storage compartment;
a second storage compartment extending from said front wall of said inner lining, said second storage compartment having a docking station;
an audio system for removably positioning in said docking station;
at least one speaker in said insulation layer and said front wall of said outer housing, said speaker connected to said docking station; and
a battery power source and an amplifier in said insulation layer, said battery power source driving said amplifier and said amplifier driving said at least one speaker, wherein when said audio system is positioned in said docking station, said audio system plays through said at least one speaker.

12. The insulated cooler of claim 11 wherein said audio system is an iPod, an MP3 player or other digital music and entertainment player.

13. The insulated cooler of claim 11 wherein said audio system is a radio receiver, an AM radio, FM radio, AM/FM radio or satellite radio.

14. The insulated cooler of claim 11 wherein said audio system is a cellphone, Blackberry or other communications device that also plays or receives music or entertainment.

15. The insulated cooler of claim 11 further comprising
an RF receiver connected to said audio system inside said insulated cooler and an RF transmitter outside said insulated cooler, said RF receiver and said RF transmitter controlling said audio system inside said insulated cooler.

16. The insulated cooler of claim 11 further comprising
a second lid on said second storage compartment for closing said second storage compartment.

17. The insulated cooler of claim 11 further comprising
a solar cell on the outer surface of said lid, said solar cell recharging said battery power source.

18. The insulated cooler of claim 11 further comprising
an acoustic port between said front wall of said outer housing through said insulation layer to the back of said at least one speaker.

19. An insulated cooler comprising
a rigid outer housing having a bottom wall, a front wall, a back wall, a left side wall and a right side wall forming a generally rectangular structure;
a rigid inner lining inside said outer housing, said inner lining having a bottom wall, a front wall, a back wall, a left side wall and a right side wall forming a generally rectangular structure;
an insulation layer between said walls of said outer housing and said walls of said inner lining;
a first storage compartment formed by said walls of said inner lining;
a first lid hinged on said back wall of said outer housing for closing said first storage compartment;
a second storage compartment extending from said front wall of said inner lining, said second storage compartment having a docking station;
a second lid on said second storage compartment for closing said second storage compartment;
an audio system for removably positioning in said docking station, wherein said audio system is an iPod, an MP3 player or other digital music and entertainment player;
an RF receiver connected to said audio system inside said insulated cooler and an RF transmitter outside said insulated cooler, said RF receiver and said RF transmitter controlling said audio system inside said insulated cooler;
at least one speaker in said insulation layer and said front wall of said outer housing, said speaker connected to said docking station;
an acoustic port between said front wall of said outer housing through said insulation layer to the back of said at least one speaker;
a battery power source and an amplifier in said insulation layer, said battery power source driving said amplifier and said amplifier driving said at least one speaker, and
a solar cell on the outer surface of said lid, said solar cell recharging said battery power source;
wherein when said audio system is positioned in said docking station, said audio system plays through said at least one speaker.
